(19) United States
(12) Patent Application Publication
(10) Pub. No.: US 2023/0150842 A1
(43) Pub. Date: May 18, 2023

(54) SYSTEM AND METHOD FOR DETECTING FLUID FLOW IN AN ELECTROLYTIC SANITIZER GENERATOR

(71) Applicants: Manuel DUARTE, Hallandale Beach, FL (US); Damaso GALLO, Boca Raton, FL (US)

(72) Inventors: Manuel DUARTE, Hallandale Beach, FL (US); Damaso GALLO, Boca Raton, FL (US)

(21) Appl. No.: 17/982,055

(22) Filed: Nov. 7, 2022

Related U.S. Application Data
(60) Provisional application No. 63/279,884, filed on Nov. 16, 2021.

(51) Int. Cl. C02F 1/461

(52) U.S. Cl. CPC C02F 1/46104; C02F 2201/4611; C02F 2103/42

(57) ABSTRACT

A system for detecting, fluid flow in an electrolytic sanitizer generator. The fluid flow detection system provides for an efficient detection of the flow of water across the electrodes or blades of an electrolysis cell. The fluid flow detection system in one embodiment includes an electronic fluid flow controller operatively coupled to the electrolytic sanitizer generator. In another embodiment the fluid flow detection system includes a light fluid flow detection system operatively coupled to the electrolytic sanitizer generator. In yet another embodiment, the fluid flow detection system includes both an electronic fluid flow controller and a light fluid flow detection system operatively coupled to the electrolytic sanitizer generator to provide redundancy to the flow detection system.

### CROSS-REFERENCE TO RELATED APPLICATIONS

The present application claims the benefit of U.S. Provisional Application No. 63/279,887, filed Nov. 16, 2021, entitled “System and Method for Detecting Fluid Flow in an Electrolytic Sanitizer Generator” which is incorporated by reference herein in its entirety.

### BACKGROUND OF THE INVENTION

Swimming pools may be treated with a sanitizing agent, such as chlorine, to maintain a clean swimming environment. The sanitizing agent may either be dispensed at a suitable rate into the water or generated by an electrolytic chlorinator positioned within a plumbing system of the swimming pool. For example, salt, such as Sodium Chloride, (“NaCl”), may be added to the swimming pool water at a tolerable or low level and the salted water may be circulated through the plumbing system and directed into the electrolytic chlorinator, which in turn generates the sanitizing agent, such as chlorine, through electrolysis. Water with the newly generated sanitizing agent may then be recirculated back into the pool. For safe operation of the electrolytic chlorinator, a continuous adequate flow of water across the electrodes or blades of an electrolysis cell of the electrolytic chlorinator is required. For example, no flow or an interrupted flow of water across the electrodes or blades of an electrolysis cell of the electrolytic chlorinator may result in a detrimental effect. Although mechanisms have been developed to monitor whether there is regular flow of water through the electrolysis cell of the electrolytic chlorinator or not, most use electromechanical switches to do so, which may be prone to frequent failures and safety concerns.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an environment employing an exemplary fluid flow detection system, in accordance with some embodiments;

FIG. 2 illustrates a diagrammatic representation of an electrolysis cell, in accordance with some embodiments;

FIGS. 3 through 7 illustrate graphical representations depicting a change in voltage per unit time across blades of the electrolysis cell, in accordance with some embodiments;

FIG. 8 illustrates a light fluid flow detection system, in accordance with some embodiments;

FIG. 9 illustrates a circuit diagram associated with the light fluid flow detection system, in accordance with some embodiments; and

FIG. 10 illustrates a method for detecting fluid flow in an electrolytic sanitizer generator, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments so as not to obscure the description with details that will be readily apparent to those of ordinary skill in the art having the benefit of the description herein.

### DETAILED DESCRIPTION OF THE INVENTION

The presently disclosed subject matter is related to electrolytic chlorinators, in particulars chlorinators configured to produce sanitizing agents, for example chlorine-based sanitizing agents.

In one aspect, a system for detecting fluid flow in an electrolytic sanitizer generator is described. The system includes an electronic fluid flow controller operatively coupled to the electrolytic sanitizer generator. The electronic fluid flow controller is configured to determine an operational state of the electrolytic sanitizer generator and determine a change in voltage per unit time across the blades of an electrolysis cell of the electrolytic sanitizer generator. The electronic fluid flow controller is further configured to detect a deviation of the change in voltage per unit time across the blades with respect to a threshold value for a predefined time duration and identify a fluid flow condition associated with the electrolytic sanitizer generator based on the detected deviation of the change in voltage per unit time. The electronic fluid flow is further configured to transmit an operating signal to operate the electrolytic sanitizer generator corresponding to the identified fluid flow condition and the determined operational state of the electrolytic sanitizer generator.

In another aspect, a method for detecting fluid flow in an electrolytic sanitizer generator is described. The method includes determining, by an electronic fluid flow controller, an operational state of the electrolytic sanitizer generator. The method further includes determining, by the electronic fluid flow controller, a change in voltage per unit time across blades of an electrolysis cell of the electrolytic sanitizer generator and detecting, by the electronic fluid flow controller, a deviation of the change in voltage per unit time across the blades with respect to a threshold value for a predefined time duration. The method further includes identifying, by the electronic fluid flow controller, a fluid flow condition associated with the electrolytic sanitizer generator based on the detected deviation of the change in voltage per unit time and transmitting, by the electronic fluid flow controller, an operating signal to operate the electrolytic sanitizer generator corresponding to the identified fluid flow condition and the determined operational state of the electrolytic sanitizer generator.

In yet another aspect, a sanitization system is described. The sanitization system includes an electrolytic sanitizer generator having an electrolysis cell for treating water and an electronic fluid flow controller operatively coupled to the electrolytic sanitizer generator. The electronic fluid flow controller is configured to determine an operational state of the electrolytic sanitizer generator and determine a change in voltage per unit time across blades of an electrolysis cell of the electrolytic sanitizer generator. The electronic fluid flow controller is further configured to detect a deviation of the change in voltage per unit time across the blades with respect to a threshold value for a predefined time duration and identify a fluid flow condition associated with the electrolytic sanitizer generator based on the detected deviation of the change in voltage per unit time. The electronic fluid flow controller is further configured to transmit an operating signal to operate the electrolytic sanitizer generator corresponding to the identified fluid flow condition and the determined operational state of the electrolytic sanitizer generator.

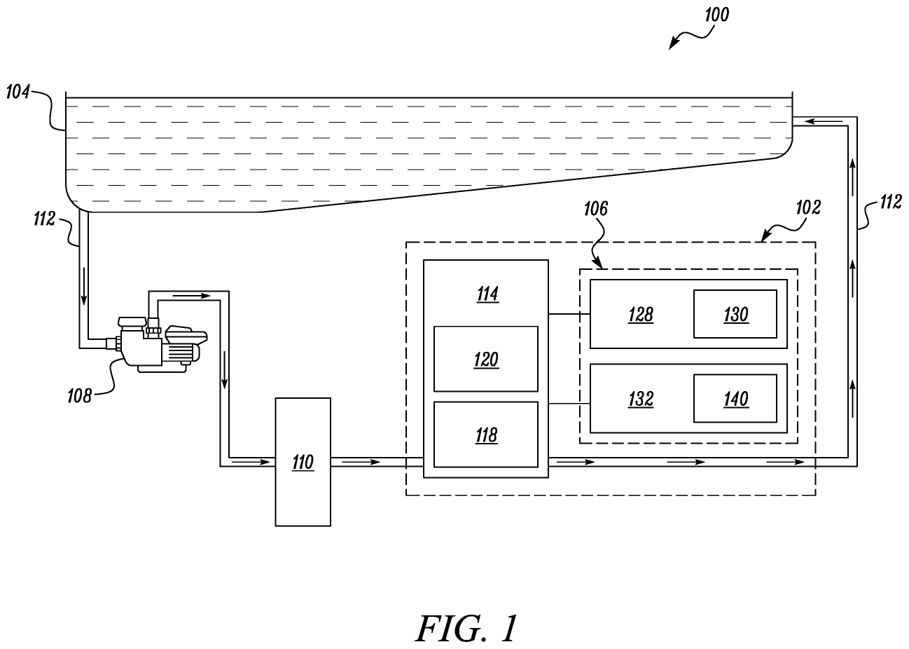

FIG. 1 illustrates an environment 100 employing an exemplary fluid flow detection system 106 in accordance with various embodiments. The fluid flow detection system 106 operating within a sanitization system 102 is configured to detect fluid flow in an electrolytic sanitizer generator 114 also operating within the sanitization system 102 in the environment 100. In an exemplary embodiment, as shown in FIG. 1, the environment 100 is a swimming pool environment. However, a person skilled in the art would appreciate that the fluid flow detection system 106 can be employed and operated in any other water-based environment, such as but not limited to, spas, hot tubs, bathtubs, therapeutic baths, or the like.

Referring to FIG. 1, the environment 100 includes a water-based unit, such as a swimming pool 104, configured to hold water. The environment 100 further includes a pump 108 coupled to the swimming pool 104 via one or more pipelines 112. The pump 108 is configured to pump the water out of the swimming pool 104 and direct the water to the electrolytic sanitizer generator 114 of the sanitization system 102 through the pipelines 112. The pump 108 is further configured to recirculate the clean or sanitized water from the electrolytic sanitizer generator 114 back to the swimming pool 104. In some embodiments, the environment 100 further includes a filter 110, coupled between the pump 108 and the sanitization system 102, to filter out any particulate matter present in the water before the water is provided to the sanitization system 102.

The sanitization system 102 in the environment 100 is configured to treat the water received from the swimming pool 104 while ensuring continuous adequate flow of water in the electrolytic sanitizer generator 114. To this end, the sanitization system 102 includes the electrolytic sanitizer generator 114 that is configured to treat the water received from the swimming pool 104 with a sanitizing agent, such as chlorine, to maintain a clean swimming environment. The sanitizing agent may either be dispensed at a suitable rate into the water in the swimming pool 104 or generated by the electrolytic sanitizer generator 114. A salt, such as Sodium Chloride or common salt, in some embodiments, is added to the water in the swimming pool 104 at a tolerable or low level and the salted water circulated through the pump 108 and directed into the electrolytic sanitizer generator 114, which in turn generates the sanitizing agent, such as chlorine.

The electrolytic sanitizer generator 114 is configured to utilize electrolysis to generate the sanitizing agent. To this end, the electrolytic sanitizer generator 114 includes an electrolysis cell 120 that is configured to electrolyze the salt dissolved in the water to produce the sanitizing agent and a controller 118 for controlling the operation of the electrolysis cell 120. The controller 118 may include one or more microprocessors, microcontrollers, DSPs (digital signal processors), state machines, logic circuitry, or any other device or devices that process information or signals based on operational or programming instructions. The controller 118 may be implemented using one or more controller technologies, such as Application Specific Integrated Circuit (ASIC), Reduced Instruction Set Computing (RISC) technology, Complex Instruction Set Computing (CISC) technology, etc. In an example, the controller 118 may comprise a printed circuit board (not illustrated), comprising one or more microcontrollers configured to facilitate the directing, as well as any suitable memory modules, sensors, output connectors, power connectors, etc., which may be necessary.

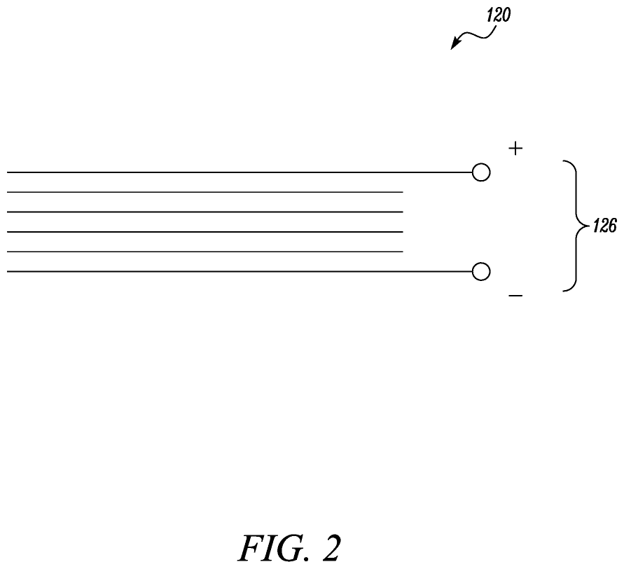

As shown in FIG. 2, the electrolysis cell 120 includes a set of electrodes or blades 126 through which the salted water is passed. In an embodiment shown in FIG. 2, the set of electrodes or blades 126 are configured to be bipolar. It will be appreciated that the set of electrodes or blades 126 in other embodiments is configured to be monopolar or any other configuration now known or in the future developed. Alternatively, the polarity of the set of electrodes or blades 126 is varied in accordance with configuration of the electrolytic sanitizer generator 114. The controller 118 is configured to control the operation of the electrolysis cell 120 by operating the electrolysis cell 120 periodically in two different operating states, for example, a charging state and a discharging state. In accordance with some embodiments, the controller 118 is configured to operate the electrolysis cell 120 periodically in two different operating states for preset time periods. In an example, the preset time periods may be, but not limited to, sixty (60), one hundred twenty (120) seconds, or any other appropriate time period.

Referring to FIG. 1 along with FIG. 2, during the charging state, the controller 118 is configured to apply an electrical current across the set of electrodes or blades 126 of the electrolysis cell 120. The electrical current passing between the electrodes 126 and through the water converts chloride ions from the salted water into the sanitizing agent. The water with the newly generated sanitizing agent is then recirculated back into the swimming pool 104 by the fluid pressure supplied by the pump 108 via the pipelines 112. During the discharging state, the controller 118 is configured to refrain from applying any electrical current across the set of electrodes or blades 126 of the electrolysis cell 120, thereby pausing the generation of the sanitizing agent.

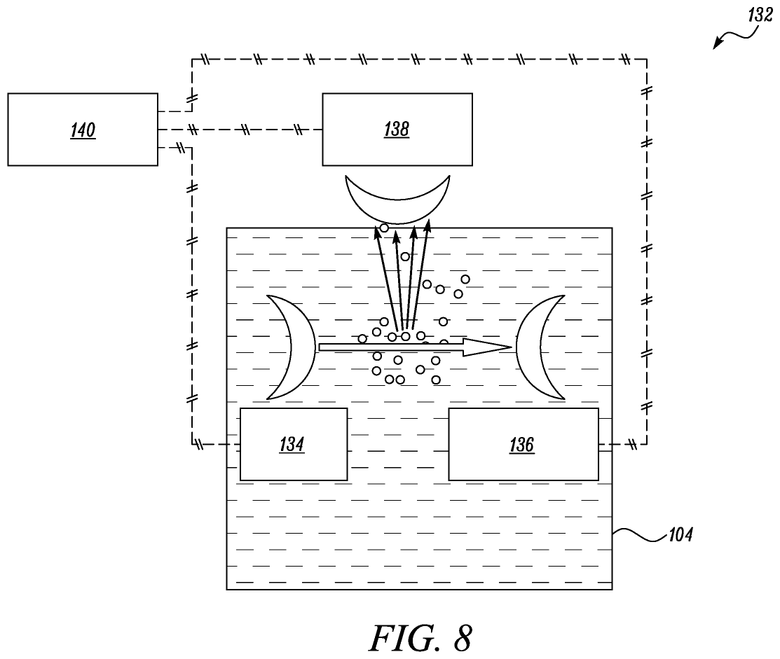

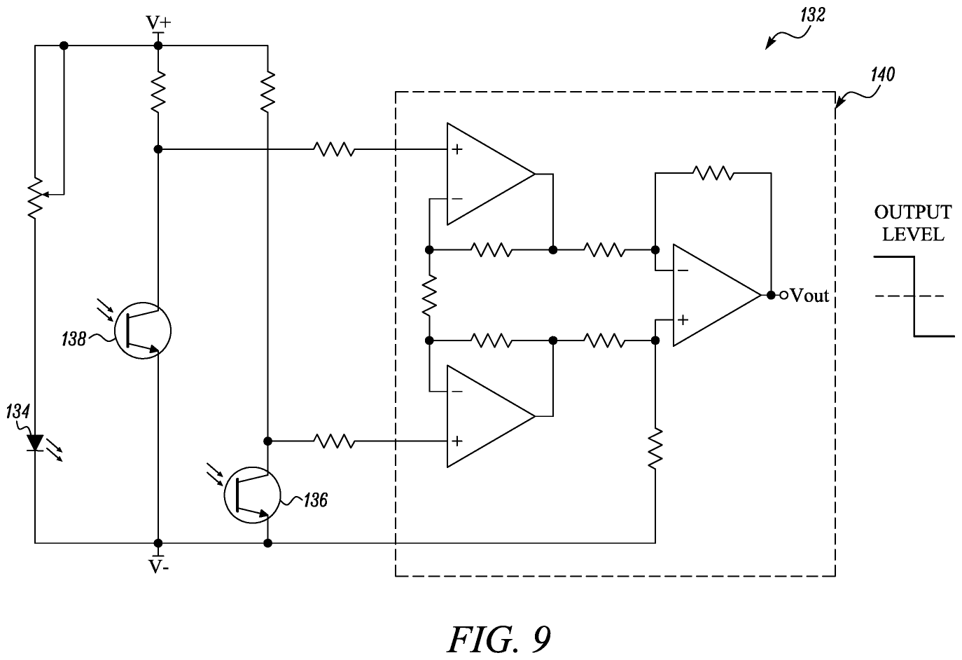

The sanitization system 102 further includes the fluid flow detection system 106 for detecting fluid flow in the electrolysis cell 120 of the electrolytic sanitizer generator 114. As stated above, for safe operation of the electrolytic sanitizer generator 114, it is required that there is continuous adequate flow of water across the electrodes or blades 126 during the charging state of the electrolysis cell 120. The fluid flow detection system 106 herein described provides for an efficient detection of flow of water across the electrodes or blades 126 of the electrolysis cell 120. To this end, the fluid flow detection system 106 includes one or more of an electronic fluid flow detection (EFFD) system 128 and a light fluid flow detection (LFFD) system 132 operatively coupled to the electrolytic sanitizer generator 114. The EFFD system 128 is configured to detect the fluid flow condition in the electrolytic sanitizer generator 114 by monitoring a change in voltage per unit time across the blades 126 of the electrolysis cell 120 of the electrolytic sanitizer generator 114. The LFFD system 132 is configured to detect the fluid flow condition in the electrolytic sanitizer generator 114 by using one or more light sensors, details of which are described further below with reference to FIGS. 8 and 9. In accordance with an embodiment, the LFFD system 132 is implemented along with the EFFD system 128 to detect the fluid flow condition in the electrolytic sanitizer generator 114, which provides redundancy to the flow detection system. In yet other embodiments, the light fluid flow detection system 132 and the EFFD system 128 are each implemented independently to detect the fluid flow condition.

The EFFD system 128 includes an electronic fluid flow controller 130, hereinafter referred to as EFF controller 130, operatively coupled to the electrolytic sanitizer generator 114. The EFF controller 130 includes, but is not limited to, one or more microprocessors, microcontrollers, DSPs (digital signal processors), state machines, logic circuitry, or any other device or devices that process information or signals based on operational or programming instructions. The EFF controller 130 in some embodiments is implemented using one or more controller technologies, such as Application Specific Integrated Circuit (ASIC), Reduced Instruction Set Computing (RISC) technology, Complex Instruction Set Computing (CISC) technology, etc. In an example, the EFF controller 130 comprises a printed circuit board (not illustrated), comprising one or more microcontrollers configured to facilitate the directing, as well as any suitable memory modules, sensors, output connectors, power connectors, and the like, as necessary.

In accordance with various embodiments, the EFF controller 130 is configured to determine an operational state of the electrolytic sanitizer generator 114. In the example as mentioned earlier, the operational state of the electrolytic sanitizer generator 114 comprises one of the charging state or the discharging state. In some embodiments, the EFF controller 130 is configured to determine the operation state of the electrolytic sanitizer generator 114 by communicating with the controller 118 of the electrolytic sanitizer generator 114. In yet some alternate embodiments, the EFF controller 130 is configured to determine the operation state of the electrolytic sanitizer generator 114 by utilizing various other techniques known in the art or in the future developed.

In an embodiment, the EFF controller 130 is configured to determine a change in voltage per unit time across the blades 126 of the electrolysis cell 120 of the electrolytic sanitizer generator 114. In an embodiment, when the electrolytic sanitizer generator 114 is operating in the charging state, the change in voltage per unit time across the blades 126 of the electrolysis cell 120 corresponds to an increase in change in voltage per unit time of the electrolysis cell 120. In such cases, the EFF controller 130 is configured to determine the increase in change in voltage per unit time of the electrolysis cell 120. Similarly, when the electrolytic sanitizer generator 114 is operating in the discharging state, the change in voltage per unit time across the blades 126 of the electrolysis cell 120 corresponds to a decrease in change in voltage per unit time of the electrolysis cell 120. In such cases, the EFF controller 130 is configured to determine the decrease in change in voltage per unit time of the electrolysis cell 120.

In some embodiments, when the electrolysis cell 120 of the electrolytic sanitizer generator 114 is operating in the charging state, a charge is developed on the set of blades 126 of the electrolysis cell 120. Similarly, when the electrolysis cell 120 of the electrolytic sanitizer generator 114 is in the discharging state, the charge on the set of blades 126 of the electrolysis cell 120 starts to discharge or drain. The embodiments herein described are directed towards monitoring this capacitive effect associated with the charging and discharging of the charge on the set of blades 126 of the electrolysis cell 120 based on the change in voltage per unit time across the blades 126 of the electrolysis cell 120. Accordingly, the EFF controller 130 is configured to evaluate a charging slope based on the determined increase in change in voltage per unit time of the electrolysis cell 120, when the operational state of the electrolytic sanitizer generator 114 is determined to be the charging state. In some embodiments, the EFF controller 130 is further configured to monitor the voltage charge rate value based on the charging slope. Similarly, the EFF controller 130 is configured to evaluate a discharging slope based on the determined decrease in change in voltage per unit time of the electrolysis cell 120, when the operational state of the electrolytic sanitizer generator 114 is determined to be the discharging state. In some embodiments, the EFF controller 130 is further configured to monitor the voltage discharge rate value based on the discharging slope. In accordance with various embodiments, the charging slope corresponds to the rate at which the charge is developed on the set of blades 126 and the discharging slope corresponds to the rate at which the charge is discharged from the set of blades 126.

In some embodiments, the EFFD system 128 further includes a signal conditioning circuitry (not shown) operatively coupled to the EFF controller 130. The signal conditioning circuitry is configured to monitor the change in voltage per unit time across the blades 126 of the electrolysis cell 120 of the electrolytic sanitizer generator 114. In an example, the signal conditioning circuitry 131 includes a dual stage voltage divider and an Analog to Digital converter (not shown). The dual stage voltage divider monitors the change in voltage per unit time and provides feedback to the Analog to Digital converter. For example, an Analog to Digital converter pin is read at one millisecond (1 ms) rate during the charging state of the electrolytic sanitizer generator 114 to evaluate the charging slope. Further in an example, the Analog to Digital converter pin is read at ten millisecond (10 ms) rate, for three (3) seconds right after the electrolytic sanitizer generator 114 begins to operate in the discharging state to evaluate the discharging slope. It will be appreciated that the time periods exemplified herein are simply for illustrative purposes; and the scope of the present disclosure includes any appropriate time periods.

In an embodiment, the EFF controller 130 is configured to detect a deviation of the change in voltage per unit time (in other words, the charging/discharging slope) across the blades 126 with respect to a threshold value for a predefined time duration. In accordance with various embodiments, the threshold value corresponds to one or more delta voltage values. For example, when the electrolytic sanitizer generator 114 is operating in the charging state, the threshold value corresponds to a maximum threshold delta voltage value associated with the charging state (hereinafter referred to as maximum voltage charge rate value (Vmax)). In an example, Vmax is two volts per minute (2V/min). Similarly, when the electrolytic sanitizer generator 114 is operating in the discharging state, the threshold value corresponds to a minimum threshold delta voltage value associated with the discharging state (hereinafter referred to as minimum voltage discharge rate value (Vmin)). In an example, Vmin is three fourths of a volt per second (0.75 V/sec). It will be appreciated that the values exemplified herein are simply for illustrative purposes; and the scope of the present disclosure includes any appropriate values.

In an embodiment, the EFF controller 130 is configured to identify a fluid flow condition associated with the electrolytic sanitizer generator 114 based on the detected deviation. For example, when the electrolytic sanitizer generator 114 is operating in the charging state and the increase in change in voltage per unit time across the blades 126 of the electrolysis cell 120 is determined to be less than the maximum voltage charge rate value (Vmax), the EFF controller 130 is configured to determine that there is adequate continuous fluid flow (i.e., NORMAL FLOW state) in the electrolytic sanitizer generator 114. Similarly, when the electrolytic sanitizer generator 114 is operating in the charging state and the increase in change in voltage per unit time across the blades 126 of the electrolysis cell 120 is determined to be greater than the maximum voltage charge rate value (Vmax), the EFF controller 130 is configured to detect the fluid flow condition as a NO-FLOW state.

In yet another example, when the electrolytic sanitizer generator is operating in the charging state and the increase in change in voltage per unit time of the electrolysis cell is less than the maximum voltage charge rate value during a first time interval of the predefined time duration and the increase in change in voltage per unit time of the electrolysis cell is greater than the maximum voltage charge rate value during a second time interval of the predefined time duration, the EFF controller 130 is configured to detect the fluid flow condition as an INTERRUPTED-FLOW state. Further, when the electrolytic sanitizer generator is operating in the discharging state and the decrease in change in voltage per unit time of the electrolysis cell is less than the minimum voltage discharge rate value, the EFF controller 130 is configured to detect the fluid flow condition as an NO-FLOW state.

Further in an embodiment, the EFF controller 130 is configured to transmit an operating signal to operate the electrolytic sanitizer generator 114 corresponding to the identified fluid flow condition and the determined operational state of the electrolytic sanitizer generator 114. For example, when the fluid flow condition is detected as the NORMAL-FLOW in the charging state, the EFF controller 130 is configured to transmit the operating signal to continue operating the electrolytic sanitizer generator in the charging state. Similarly, when the fluid flow condition is detected as the NO-FLOW in the charging state, the EFF controller 130 is configured to transmit the operating signal to change the operating state of the electrolytic sanitizer generator to the discharging state. Further, when the fluid flow condition is detected as the INTERRUPTED-FLOW in the charging state, the EFF controller 130 is configured to transmit the operating signal to change the operating state of the electrolytic sanitizer generator to the discharging state. Further, when the fluid flow condition is detected as the NO-FLOW in the discharging state, the EFF controller 130 is configured to transmit the operating signal to maintain the operating state of the electrolytic sanitizer generator 114 in the discharging state.

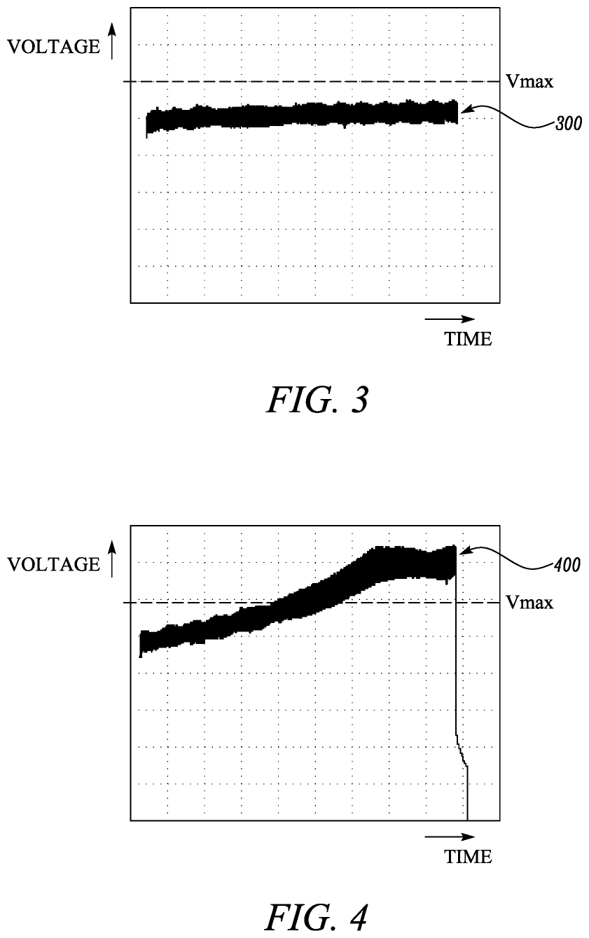

FIGS. 3 through 7 illustrate example graphical representations depicting a change in voltage per unit time across blades 126 of the electrolysis cell 120 to identify fluid flow condition in accordance with the embodiments. For example, FIG. 3 depicts a scenario in which the electrolytic sanitizer generator 114 is operating in the charging state. In such cases, the EFFD system 128 periodically monitors the increase in change in voltage per unit time across the blades 126 of the electrolysis cell 120. As can be seen in FIG. 3, the detected deviation of the increase in the change in voltage per unit time 300 does not rise above Vmax, and maintains a constant rate, for example two thirds volt per minute (0.6 V/min). It will be appreciated that the values exemplified herein are simply for illustrative purposes; and the scope of the present disclosure includes any appropriate values. Accordingly, the EFF controller 130 is configured to determine that there is adequate continuous fluid flow (i.e., Normal Flow) in the electrolytic sanitizer generator 114. The EFF controller 130, in this scenario, transmits an operating signal to the controller 118 to continue operating the electrolytic sanitizer generator 114 in the charging state.

In another scenario, as shown in FIG. 4, the electrolytic sanitizer generator 114 is operating in the charging state, however the detected deviation of the increase in the change in voltage per unit time 400 is greater than the maximum voltage charge rate value (Vmax). Accordingly, the EFF controller 130 is configured to detect the fluid flow condition as a NO-FLOW state. Accordingly, the EFF controller 130 transmits an operating signal to the controller 118 to change the operating state of the electrolytic sanitizer generator 114 to the discharging state.

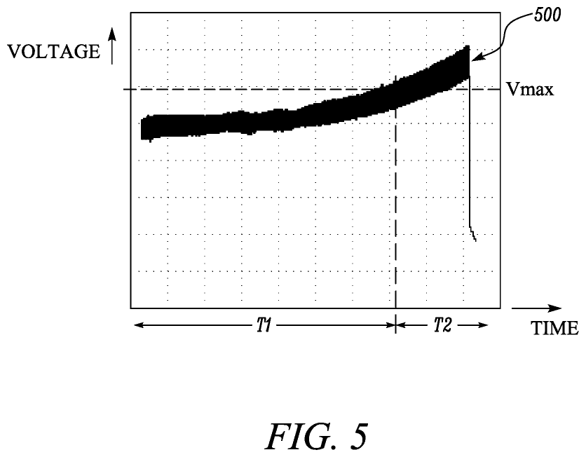

In yet another example, shown in FIG. 5, the electrolytic sanitizer generator 114 is operating in the charging state, however the detected deviation of the increase in the change in voltage per unit time 500 is less than the maximum voltage charge rate value (Vmax) during a first-time interval (T1) and greater than the maximum voltage charge rate value (Vmax) during a second-time interval (T2). Accordingly, the EFF controller 130 is configured to determine that the flow of the fluid/water in the electrolytic sanitizer generator 114 is not continuous. In other words, the EFF controller 130 is configured to detect the fluid flow condition as an INTERRUPTED-FLOW state. Accordingly, the EFF controller 130 transmits an operating signal to the controller 118 to change the operating state of the electrolytic sanitizer generator 114 to the discharging state.

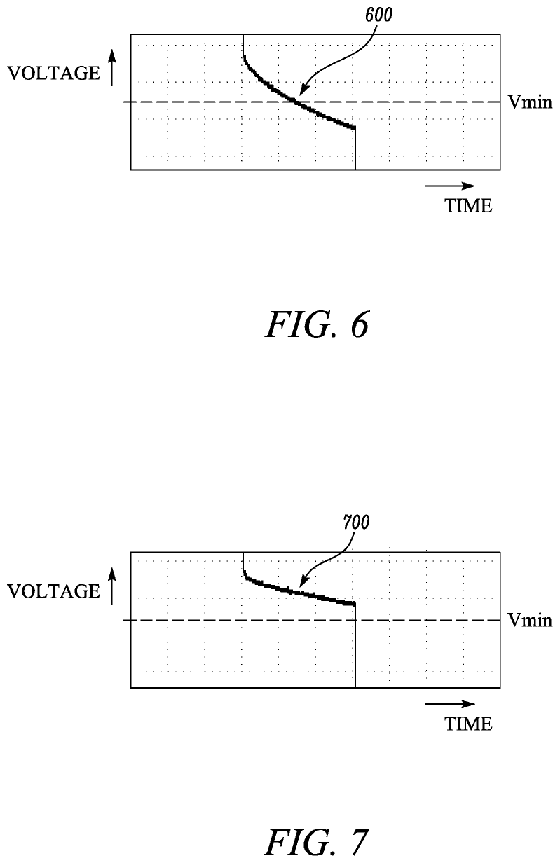

In yet another example, shown in FIG. 6, the electrolytic sanitizer generator 114 is operating in the discharging state and the detected deviation of the decrease in the change in voltage per unit time is less than the minimum voltage charge rate value (Vmin). In this case, the detected deviation of decrease in the change in voltage per unit time maintains a near constant rate, which is less than the minimum voltage charge rate value. This indicates that the charge developed on the blades 126 is decreasing at an optimum rate with the flow of fluid or water across the blades 126. Accordingly, the EFF controller 130 is configured to determine that the flow of the fluid/water in the electrolytic sanitizer generator 114 is continuous and detect the fluid flow condition as a NORMAL-FLOW state. Accordingly, the EFF controller 130 transmits an operating signal to the controller 118 to maintain the operating state of the electrolytic sanitizer generator 114 to the discharging state.

In yet another example, as shown in FIG. 7, the electrolytic sanitizer generator 114 is operating in the discharging state and the detected deviation of the decrease in the change in voltage per unit time is greater than the minimum voltage charge rate value (Vmin). This indicates that the charge developed on the blades 126 is not decreasing at the optimum rate as there is no flow of fluid or water across the blades 126. Accordingly, the EFF controller 130 is configured to determine that the flow of the fluid/water in the electrolytic sanitizer generator 114 is not proper and detect the fluid flow condition as a NO-FLOW state. Accordingly, the EFF controller 130 transmits an operating signal to the controller 118 to maintain the operating state of the electrolytic sanitizer generator 114 to the discharging state.

Referring to FIG. 1, the LFFD system 132 in the fluid flow detection system 106 includes a light fluid flow (LFF) controller 140 configured to detect the fluid flow condition in the electrolytic sanitizer generator 114 by using one or more light sensors. The LFF controller 140 includes one or more microprocessors, microcontrollers, DSPs (digital signal processors), state machines, logic circuitry, or any other device or devices that process information or signals based on operational or programming instructions. The LFF controller 140 may be implemented using one or more controller technologies, such as Application Specific Integrated Circuit (ASIC), Reduced Instruction Set Computing (RISC) technology, Complex Instruction Set Computing (CISC) technology, etc. In an example, the LFF controller 140 comprises a printed circuit board (not illustrated), comprising one or more microcontrollers configured to facilitate the directing, as well as any suitable memory modules, sensors, output connectors, power connectors, and the like.

The LFFD system 132 is configured to monitor a hydrogen bubble concentration of the swimming pool water, and accordingly identify a fluid flow condition associated with the electrolytic sanitizer generator 114. As discussed above, the LFFD system 132 in some embodiments is associated with the EFFD system 128 or in other embodiments operates as a standalone system associated with the electrolytic sanitizer generator 114. In another example, the LFFD system 132 is operative in case the EFFD system 128 fails or vice-versa.

The detailed functioning of the LFFD system 132 and the LFF controller 140 will now be described with reference to FIGS. 8 and 9. As shown in FIGS. 8 and 9, the LFFD system 132 includes an Infrared (IR) light source 134 configured to irradiate light on the water, for example, at an outlet opening of the electrolytic sanitizer generator 114 of FIG. 1. The LFFD system 132 further includes an IR transmitted light sensor 136 configured to capture direct light component of the irradiated light. The LFFD system 132 further includes an IR scattered light sensor 138 configured to capture scattered light component of the irradiated light. In an embodiment, the captured scattered light component is indicative of an amount of hydrogen bubble concentration in the water.

As shown in FIGS. 8 and 9, the LFF controller 140 is operatively coupled to the IR light source 134, the IR transmitted light sensor 136, and the IR scattered light sensor 138. In an embodiment, the LFF controller 140 is configured to compare the captured scattered light component from the IR scattered light sensor 138 with a predefined threshold scattered light value. In accordance with some embodiments, as depicted in FIG. 9, the LFF controller 140 includes signal conditioning amplifiers to compare the captured scattered light component with the predefined threshold scattered light value. The amplifiers in some embodiments are instrumentation while in other embodiments are operational amplifiers as known to person skilled in the art. In accordance with various embodiments, the predefined threshold scattered light value is indicative of an optimum hydrogen bubble concentration in the water, which further is indicative of the presence or absence of optimum water flow in the electrolytic sanitizer generator 114. It will be appreciated by those of ordinary skill in the art that a high hydrogen bubble concentration is indicative of poor or low water flow.

In an embodiment, the LFF controller 140 is further configured to identify the fluid flow condition associated with the electrolytic sanitizer generator 114 based upon the comparison. In an embodiment, when the electrolytic sanitizer generator 114 is operating in the charging state, and when the captured scattered light component is less than or equal to the predefined threshold scattered light value, the LFF controller 140 is configured to determine that there is adequate continuous fluid flow (i.e., NORMAL FLOW state) in the electrolytic sanitizer generator 114. In an embodiment, when the electrolytic sanitizer generator 114 is operating in the charging state, the LFF controller 140 is configured to identify the fluid flow condition as a NO-FLOW state when the captured scattered light component is greater than the predefined threshold scattered light value. Similarly, when the electrolytic sanitizer generator 114 is operating in the charging state, however when the captured scattered light component is less than or equal to the predefined threshold scattered light value during a first-time interval (T1) and greater than the predefined threshold scattered light value during a second-time interval (T2). Accordingly, the LFF controller 140 is configured to determine that the flow of the fluid/water in the electrolytic sanitizer generator 114 is not continuous. In other words, the LFF controller 140 is configured to detect the fluid flow condition as an INTERRUPTED-FLOW state.

In an embodiment, the LFF controller 140 is further configured to transmit the operating signal to the controller 118 to operate the electrolytic sanitizer generator 114 corresponding to the identified fluid flow condition. For example, when the fluid flow condition is detected as the NORMAL-FLOW in the charging state, the LFF controller 140 is configured to transmit the operating signal to continue operating the electrolytic sanitizer generator in the charging state. Further in an example, the LFF controller 140 transmits the operating signal to the controller 118 to change the operating state of the electrolytic sanitizer generator to the discharging state when the fluid flow condition is detected as the NO-FLOW state in the charging state. Further, when the fluid flow condition is detected as the INTERRUPTED-FLOW in the charging state, the LFF controller 140 is configured to transmit the operating signal to change the operating state of the electrolytic sanitizer generator to the discharging state. Further, when the fluid flow condition is detected as the NO-FLOW in the discharging state, the LFF controller 140 is configured to transmit the operating signal to maintain the operating state of the electrolytic sanitizer generator 114 in the discharging state.

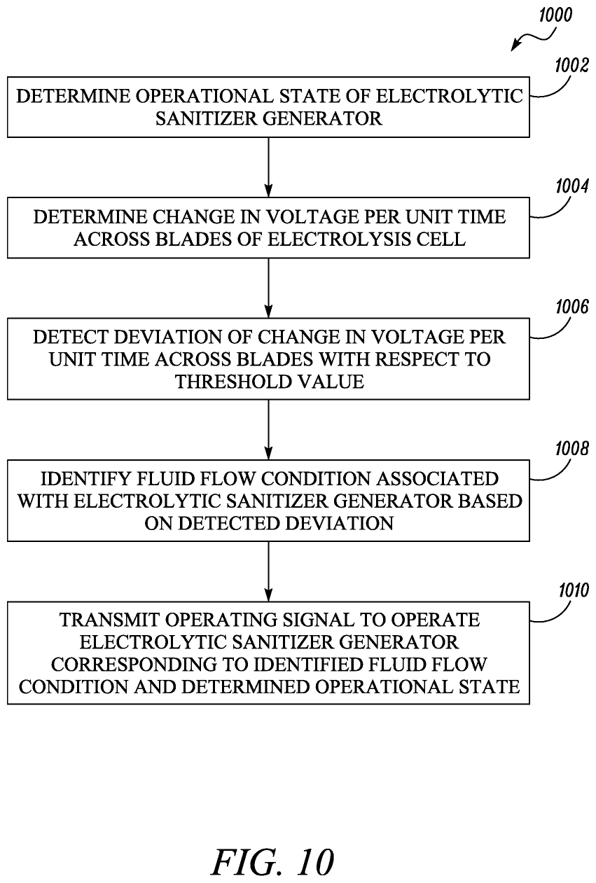

FIG. 10 illustrates a method 1000 for detecting fluid flow in an electrolytic sanitizer generator 114. At Operation 1002, the electronic fluid flow controller 130 determines the operational state of the electrolytic sanitizer generator 114. At Operation 1004, the electronic fluid flow controller 130 determines the change in voltage per unit time across blades 126 of the electrolysis cell 120 of the electrolytic sanitizer generator 114. At Operation 1006, the electronic fluid flow controller 130, detects the deviation of the change in voltage per unit time across the blades 126 with respect to the threshold value for the predefined time duration and identifies the fluid flow condition associated with the electrolytic sanitizer generator 114 based on the detected deviation of the change in voltage per unit time at Operation 1008. At Operation 1010, the electronic fluid flow controller 130 transmits the operating signal to operate the electrolytic sanitizer generator 114 corresponding to the identified fluid flow condition and the determined operational state of the electrolytic sanitizer generator 114.

The present disclosure provides an efficient and effective method to detect the fluid flow in the electrolytic sanitizer generator 114. As explained in the foregoing description, the electronic fluid flow detection (EFFD) system 128 of the present disclosure actively monitors the charge related aspects of the blades 126 of the electrolysis cell 120 and determine the fluid flow condition based on the charge on the blades of the electrolysis cell 120. The decision with respect to switching the operation state of the electrolytic sanitizer generator 114 is being taken based upon the evaluated deviation of the charge exceeding a threshold. This avoids the need to install any additional hardware, such as mechanical switches, to detect when there is continuous adequate fluid flow.

Moreover, by implementing the light fluid flow system 132 along with the EFFD system 128, a fail-safe water-based environment can be provided. For example, the EFFD system 128 and light fluid flow system 132 are operated as overriding systems for each other, in case any one of the systems fails. Thus, the fluid flow detection system 106 as explained in the foregoing description advantageously detects a fluid flow condition associated with the electrolytic sanitizer generator 114, and accordingly helps avoiding the electrolytic sanitizer generator 114 to operate in a no fluid flow. The system 106 thereby ensures a safe operation of the electrolytic sanitizer generator 114.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or stricture that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed. Description, it can be seen that various features are grouped together in various embodiments for the purpose of streamlining the description. This method is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A system for detecting fluid flow in an electrolytic sanitizer generator, the system comprising:
an electronic fluid flow controller operatively coupled to the electrolytic sanitizer generator, the electronic fluid flow controller being configured to:
determine an operational state of the electrolytic sanitizer generator;
determine a change in voltage per unit time across the blades of an electrolysis cell of the electrolytic sanitizer generator;
detect a deviation of the change in voltage per unit time across the blades with respect to a threshold value for a predefined time duration;
identify a fluid flow condition associated with the electrolytic sanitizer generator based on the detected deviation of the change in voltage per unit time; and
transmit an operating signal to operate the electrolytic sanitizer generator corresponding to the identified fluid flow condition and the determined operational state of the electrolytic sanitizer generator.

2. The system of claim 1, wherein the operational state of the electrolytic sanitizer generator is one of charging state or discharging state, wherein the electronic fluid flow controller is configured to monitor:
a voltage charge rate value when the operational state of the electrolytic sanitizer generator is determined to be the charging state; and
a voltage discharge rate value when the operational state of the electrolytic sanitizer generator is determined to be the discharging state.

3. The system of claim 2, wherein the change in voltage per unit time across the blades of the electrolysis cell corresponds to:
an increase in change in voltage per unit time of the electrolysis cell when the electrolytic sanitizer generator is operating in the charging state; and
a decrease in change in voltage per unit time of the electrolysis cell when the electrolytic sanitizer generator is operating in the discharging state.

4. The system of claim 3, wherein the threshold value corresponds to a maximum voltage charge rate value when the electrolytic sanitizer generator is operating in the charging state, and wherein the electronic fluid flow controller is configured to:
detect the fluid flow condition as a NO-FLOW state when the increase in change in voltage per unit time of the electrolysis cell is greater than the maximum voltage charge rate value; and
transmit the operating signal to change the operating state of the electrolytic sanitizer generator to the discharging state when the fluid flow condition is detected as the NO-FLOW state.

5. The system of claim 4, when the electrolytic sanitizer generator is operating in the discharging state, the threshold value corresponds to a minimum voltage discharge rate value, wherein the electronic fluid flow controller is configured to:
detect the fluid flow condition as the NO-FLOW state when the decrease in change in voltage per unit time of the electrolysis cell is less than the minimum voltage discharge rate value; and
transmit the operating signal to maintain the electrolytic sanitizer generator in the discharging state.

6. The system of claim 3, wherein the threshold value corresponds to a maximum voltage charge rate value when the electrolytic sanitizer generator is operating in the charging state, and wherein the electronic fluid flow controller is configured to:
detect the fluid flow condition as an INTERRUPTED-FLOW state when the increase in change in voltage per unit time of the electrolysis cell is less than the maximum voltage charge rate value during a first time interval of the predefined time duration and the increase in change in voltage per unit time of the electrolysis cell is greater than the maximum voltage charge rate value during a second time interval of the predefined time duration; and
transmit the operating signal to change the operating state of the electrolytic sanitizer generator to the discharging state when the fluid flow condition is detected as the INTERRUPTED-FLOW state.

7. The system of claim 6, when the electrolytic sanitizer generator is operating in the discharging state, the threshold value corresponds to a minimum voltage discharge rate value, wherein the electronic fluid flow controller is configured to:
detect the fluid flow condition as the NO-FLOW state when the decrease in change in voltage per unit time of the electrolysis cell is less than the minimum voltage discharge rate value; and
transmit the operating signal to maintain the electrolytic chlorinator in the discharging state.

8. The system of claim 3, wherein the threshold value corresponds to a minimum voltage discharge rate value when the electrolytic sanitizer generator is operating in the discharging state, wherein the electronic fluid flow controller is configured to:
detect the fluid flow condition as a NO-FLOW state when the decrease in change in voltage per unit time of the electrolysis cell is less than the minimum voltage discharge rate value during the predefined time duration; and
transmit the operating signal to maintain the electrolytic sanitizer generator in the discharging state.

9. The system of claim 1 further including:
a signal conditioning circuitry operatively coupled to the electronic fluid flow controller, the signal conditioning circuitry configured to monitor the change in voltage per unit time across the blades of the electrolysis cell of the electrolytic sanitizer generator.

10. The system of claim 1, further comprising:
a light fluid flow detection system operatively coupled to the electrolytic sanitizer generator, the light flow detection system comprising:
an IR light source to irradiate light on the water at an outlet of the electrolytic sanitizer generator;
an IR transmitted light sensor configured to capture direct light component of the irradiated light;
an IR scattered light sensor configured to capture scattered light component of the irradiated light; and
a light fluid flow controller operatively coupled to the IR light source, the IR transmitted light sensor, and the IR scattered light sensor, the light fluid flow controller being configured to:
compare the captured scattered light component with a predefined threshold scattered light value,
identify the fluid flow condition associated with the electrolytic sanitizer generator based upon the comparison, and
transmit the operating signal to operate the electrolytic sanitizer generator corresponding to the identified fluid flow condition.

11. A system for detecting fluid flow in an electrolytic sanitizer generator, the system comprising:
a light fluid flow detection system operatively coupled to the electrolytic sanitizer generator, the light flow detection system comprising:
an IR light source to irradiate light on the water at an outlet of the electrolytic sanitizer generator;
an IR transmitted light sensor configured to capture direct light component of the irradiated light;
an IR scattered light sensor configured to capture scattered light component of the irradiated light; and
a light fluid flow controller operatively coupled to the IR light source, the IR transmitted light sensor, and the IR scattered light sensor, the light fluid flow controller being configured to:
compare the captured scattered light component with a predefined threshold scattered light value,
identify the fluid flow condition associated with the electrolytic sanitizer generator based upon the comparison, and
transmit the operating signal to operate the electrolytic sanitizer generator corresponding to the identified fluid flow condition.

12. The system of claim 11, wherein the captured scattered light component is indicative of an amount of hydrogen bubble concentration in the water, and the predefined threshold scattered light value is indicative of an optimum hydrogen bubble concentration in the water, wherein the hydrogen bubble concentration is further indicative of the presence or absence of optimum water flow.

13. The system of claim 12, wherein when the electrolytic sanitizer generator is operating in the charging state, the light fluid flow controller is configured to:
identify the fluid flow condition as a NO-FLOW state when the captured scattered light component is greater than the predefined threshold scattered light value; and
transmit the operating signal to change the operating state of the electrolytic sanitizer generator to the discharging state when the fluid flow condition is detected as the NO-FLOW state.

14. A method for detecting fluid flow in an electrolytic sanitizer generator the method comprising:
determining, by an electronic fluid flow controller, an operational state of the electrolytic sanitizer generator;
determining, by the electronic fluid flow controller, a change in voltage per unit time across blades of an electrolysis cell of the electrolytic sanitizer generator;
detecting, by the electronic fluid flow controller, a deviation of the change in voltage per unit time across the blades with respect to a threshold value for a predefined time duration;
identifying, by the electronic fluid flow controller, a fluid flow condition associated with the electrolytic sanitizer generator based on the detected deviation of the change in voltage per unit time; and
transmitting, by the electronic fluid flow controller, an operating signal to operate the electrolytic sanitizer generator corresponding to the identified fluid flow condition and the determined operational state of the electrolytic sanitizer generator.

15. The method of claim 14, wherein the operational state of the electrolytic sanitizer generator is one of charging state or discharging state, wherein the electronic fluid flow controller is configured to monitor:
a voltage charge rate value when the operational state of the electrolytic sanitizer generator is determined to be the charging state; and
a voltage discharge rate value when the operational state of the electrolytic chlorinator is determined to be the discharging state.

16. The method of claim 15, wherein the change in voltage per unit time across the blades of the electrolysis cell corresponds to:
an increase in change in voltage per unit time of the electrolysis cell when the electrolytic sanitizer generator is operating in the charging state; and
a decrease in change in voltage per unit time of the electrolysis cell when the electrolytic sanitizer generator is operating in the discharging state.

17. The method of claim 16, wherein the threshold value corresponds to a maximum voltage charge rate value when the electrolytic sanitizer generator is operating in the charging state, and wherein the method further comprises:
detecting, by the electronic fluid flow controller, the fluid flow condition as a NO-FLOW state when the increase in change in voltage per unit time of the electrolysis cell is greater than the maximum voltage charge rate value; and
transmitting, by the electronic fluid flow controller, the operating signal to change the operating state of the electrolytic sanitizer generator to the discharging state when the fluid flow condition is detected as the NO-FLOW state.

18. The method of claim 17, when the electrolytic sanitizer generator is operating in the discharging state, the threshold value corresponds to a minimum voltage discharge rate value, wherein the method further comprises:
detecting, by the electronic fluid flow controller, the fluid flow condition as the NO-FLOW state when the decrease in change in voltage per unit time of the electrolysis cell is less than the minimum voltage discharge rate value; and
transmitting, by the electronic fluid flow controller, the operating signal to maintain the electrolytic sanitizer generator in the discharging state.

19. The method of claim 16, wherein the threshold value corresponds to a maximum voltage charge rate value when the electrolytic sanitizer generator is operating in the charging state, and wherein the method further comprises:
detecting, by the electronic fluid flow controller, the fluid flow condition as an INTERRUPTED-FLOW state when the increase in change in voltage per unit time of the electrolysis cell is less than the maximum voltage charge rate value during a first time interval of the predefined time duration and the increase in change in voltage per unit time of the electrolysis cell is greater than the maximum voltage charge rate value during a second time interval of the predefined time duration; and
transmitting, by the electronic fluid flow controller, the operating signal to change the operating state of the electrolytic sanitizer generator to the discharging state when the fluid flow condition is detected as the INTERRUPTED-FLOW state.

20. The method of claim 19, when the electrolytic sanitizer generator is operating in the discharging state, the threshold value corresponds to a minimum voltage discharge rate value, wherein the method further comprises:
detecting, by the electronic fluid flow controller, the fluid flow condition as the NO-FLOW state when the decrease in change in voltage per unit time of the electrolysis cell is less than the minimum voltage discharge rate value; and
transmitting, by the electronic fluid flow controller, the operating signal to maintain the electrolytic chlorinator in the discharging state.
